(19) United States
(12) Patent Application Publication
(10) Pub. No.: US 2026/0098757 A1
(43) Pub. Date: Apr. 9, 2026

(54) DETECTION SYSTEM AND DETECTION METHOD THEREOF

(71) Applicant: Industrial Technology Research Institute, Hsinchu (TW)

(72) Inventors: Yi Chen, Nantou County (TW); Tze-An Liu, Hsinchu City (TW); Kao-Chi Lin, Kaohsiung City (TW)

(73) Assignee: Industrial Technology Research Institute, Hsinchu (TW)

(21) Appl. No.: 19/015,452

(22) Filed: Jan. 9, 2025

(30) Foreign Application Priority Data
Oct. 9, 2024 (TW) 113138508

(51) Int. Cl. G01J 3/02; G01J 3/28

(52) U.S. Cl. CPC G01J 3/027; G01J 3/28

(57) ABSTRACT

A detection system for detecting a bandwidth of an object to be tested is provided. The detection system includes a frequency-tunable laser module, a photoconductive semiconductor switch, and a digital acquisition system. The frequency-tunable laser module is configured to provide a first mixed frequency light and a second mixed frequency light, with a phase difference or a frequency difference between the first mixed frequency light and the second mixed frequency light. The photoconductive semiconductor switch is configured to receive the first mixed frequency light, the object to be tested is configured to receive the second mixed frequency light, and the photoconductive semiconductor switch and the object to be tested are coupled to output a mixed frequency signal. The digital acquisition system is configured to receive the mixed frequency signal to detect the bandwidth of the object to be tested. A detection method is also provided.

### CROSS-REFERENCE TO RELATED APPLICATION

This application claims the priority benefit of Taiwan Application No. 113138508, filed on Oct. 9, 2024. The entirety of the above-mentioned patent application is hereby incorporated by reference herein.

### TECHNICAL FIELD

The disclosure relates to a detection system and a detection method thereof.

### BACKGROUND

With the development of communication transmission, the demand for bandwidth in electronic elements has increased. However, the current range of bandwidth measurements supported by conventional analytical instruments is insufficient (for instance, approximately 100 GHz). Additionally, with the advancement of silicon photonic elements, their bandwidth is also increasing (for instance, exceeding 200 GHz). If the market cannot provide adequate measurement means capable of measuring high-bandwidth elements, the application and development of silicon photonic elements may be limited.

On the other hand, conventional measurement of bandwidth specifications of silicon photonic elements (such as photodiodes or electro-optic modulators) requires high-resolution spectrometers or frequency spectrum analyzers. High-frequency signals are transmitted through wires, requiring detection instruments to incorporate built-in high-speed photodiodes and frequency dividers. These instruments are expensive, thereby increasing detection costs associated with the silicon photonic elements.

### SUMMARY

One of the exemplary embodiments provides a detection system adapted to detect a high-bandwidth object to be tested, and costs of instruments of the detection system may be reduced.

One of the exemplary embodiments provides a detection method for detecting a high-bandwidth object to be tested and effectively reducing detection costs.

One of the exemplary embodiments provides a detection system for detecting a bandwidth of an object to be tested. The detection system includes a frequency-tunable laser module, a photoconductive semiconductor switch, and a digital acquisition system. The frequency-tunable laser module is configured to provide a first mixing frequency light and a second mixing frequency light, with a phase difference or a frequency difference between the first mixing frequency light and the second mixing frequency light. The photoconductive semiconductor switch is configured to receive the first mixing frequency light, the object to be tested is configured to receive the second mixing frequency light, and the photoconductive semiconductor switch and the object to be tested are coupled to output a mixing frequency signal. The digital acquisition system is configured to receive the mixing frequency signal to detect the bandwidth of the object to be tested.

One of the exemplary embodiments provides a detection method for detecting a bandwidth of an object to be tested. The detection method includes: providing a first mixing frequency light and a second mixing frequency light by a frequency-tunable laser module, with a phase difference or a frequency difference between the first mixing frequency light and the second mixing frequency light; receiving the first mixing frequency light by a photoconductive semiconductor switch, receiving the second mixing frequency light by the object to be tested, and outputting a mixing frequency signal by the photoconductive semiconductor switch and the object to be tested after the photoconductive semiconductor switch and the object to be tested are coupled; receiving the mixing frequency signal by a digital acquisition system to detect the bandwidth of the object to be tested.

To make this disclosure more clearly comprehensible, exemplary embodiments are described below in detail with reference to the accompanying drawings.

### BRIEF DESCRIPTION OF THE DRAWINGS

The accompanying drawings are included to provide a further understanding of the disclosure, and the accompanying drawings are incorporated in and constitute a part of this specification. The drawings illustrate the exemplary embodiments of the disclosure, and together with the description, serve to explain the principle of the disclosure.

FIG. 1 is a schematic diagram illustrating a detection by a detection system according to an embodiment of the disclosure.

FIG. 2 is a schematic diagram illustrating a detection by a detection system according to an embodiment of the disclosure.

FIG. 3A is a schematic diagram illustrating a detection by a detection system according to an embodiment of the disclosure.

FIG. 3B is a schematic diagram illustrating a detection by the detection system depicted in FIG. 3B according to a modified embodiment of the disclosure.

FIG. 4A is a schematic diagram illustrating a detection by a detection system according to an embodiment of the disclosure.

FIG. 4B is a schematic diagram illustrating a detection by the detection system depicted in FIG. 4B according to a modified embodiment of the disclosure.

FIG. 5 is a schematic diagram illustrating a detection by a detection system according to an embodiment of the disclosure.

### DETAILED DESCRIPTION OF DISCLOSURED EMBODIMENTS

The directional terminologies mentioned in the disclosure, such as “upper,” “lower,” “front,” “rear,” “left,” “right,” and so on, are used with reference to the accompanying drawings. Therefore, the directional terminologies used are for illustration, but not to limit the disclosure. In the accompanying drawings, each drawing shows the general features of the methods, structures and/or materials adopted in a specific embodiment. However, the drawings should not be construed as defining or limiting the scope or nature covered by the embodiments. For instance, for clarity, the relative size, thickness, and position of each layer, region, and/or structure may be reduced or enlarged.

The terminology “about,” “approximately,” “essentially,” or “substantially” used herein includes the average of the stated value and an acceptable range of deviations from the particular value as determined by those skilled in the art. For instance, the terminology “about” may refer to as being within one or more standard deviations of the stated value, or within ±30%, ±20%, ±15%, ±10%, or ±5%. Furthermore, the terminology “about,” “approximately,” “essentially,” or “substantially” as used herein may be chosen from a range of acceptable deviations or standard deviations depending on the measurement properties, cutting properties, or other properties, rather than one standard deviation for all properties.

In the accompanying drawings, each drawing shows the general features of the methods, structures and/or materials adopted in a specific embodiment. However, the drawings should not be construed as defining or limiting the scope or nature covered by the embodiments. For instance, for clarity, the relative size, thickness, and position of each layer, region, and/or structure may be reduced or enlarged, and/or some elements or film layers may be omitted from the illustration.

It should be understood that when an element, such as a layer, a film, a region, or a substrate is referred to as being “on” or “connected to” another element, it can be directly on or connected to the another element, or an intermediate element may also be present. By contrast, when an element is referred to as being “directly on” or “directly connected to” another element, no intermediate element is present. As used herein, being “connected” may refer to a physical and/or electrical connection. Furthermore, being “electrically connected” may refer to the presence of other elements between the two elements.

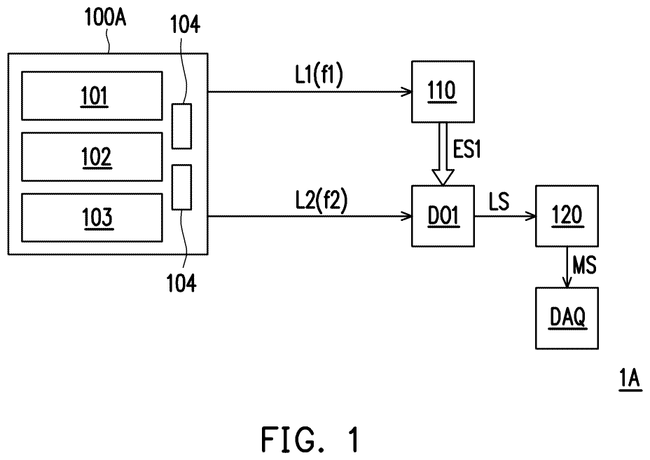

FIG. 1 is a schematic diagram illustrating a detection by a detection system according to an embodiment of the disclosure. With reference to FIG. 1, a detection system 1A may be configured to detect a bandwidth of a first object to be tested DO1. The detection system 1A includes a frequency-tunable laser module 100A, a photoconductive semiconductor switch 110, and a digital acquisition system DAQ. The frequency-tunable laser module 100A is configured to provide a first mixing frequency light L1 and a second mixing frequency light L2, where the first mixing frequency light L1 has a first frequency f1, for instance, and the second mixing frequency light L2 has a second frequency f2, for instance, with a frequency difference between the first frequency f1 and the second frequency f2. The photoconductive semiconductor switch 110 is configured to receive the first mixing frequency light L1, and the first object to be tested DO1 is configured to receive the second mixing frequency light L2.

The frequency-tunable laser module 100A may include, for instance, a first light source 101, a second light source 102, and a third light source 103. Each of the first light source 101, the second light source 102, and the third light source 103 may be a continuous wave (CW) laser source, respectively, while the number of light sources should not be construed as a limitation in the disclosure. Besides, at least one of the first light source 101, the second light source 102, and the third light source 103 may be a frequency tunable laser source, so as to provide frequency-tunable mixing frequency laser. For instance, a tunable frequency range of a wavelength of the laser emitted by the frequency-tunable laser module 100A may be greater than or equal to 200 GHz, which should not be construed as a limitation in the disclosure. The frequency-tunable laser module 100A may further include a light frequency mixer 104 configured to mix a frequency of a light beam emitted by the first light source 101 (for instance, with a frequency of ν1) and a frequency of a light beam emitted by the second light source 102 (for instance, with a frequency of ν2), so as to generate a first mixing frequency light L1 using the beat frequency, i.e., the first frequency f1=ν1−ν2. Similarly, the light frequency mixer 104 may also be configured to mix the frequency of the light beam emitted by the second light source 102 and a frequency of a light beam emitted by the third light source 103 (for instance, with a frequency of ν3), so as to generate a second mixing frequency light L2 using the beat frequency, i.e., the second frequency f2=ν2−ν3. The frequency-tunable laser module 100A may further include a light splitter or a reflective lens assembly (both not shown) configured to provide the first mixing frequency light L1 and the second mixing frequency light L2 to the photoconductive semiconductor switch 110 and the first object to be tested DO1 respectively, which should not be construed as a limitation in the disclosure. In some embodiments, the first frequency f1 and the second frequency f2 may fall within the terahertz (THz) frequency band, which should not be construed as a limitation in the disclosure.

The photoconductive semiconductor switch 110 (PCSS) is a high-speed semiconductor switch device that controls the generation and recombination of electrons and holes in a semiconductor material of the photoconductive semiconductor switch 110 through light, so as to switch on or switch off the photoconductive semiconductor switch 110. Compared to conventional high-voltage switch elements, the photoconductive semiconductor switch 110 has advantages of a simple structure easy for integration, a small inductance coefficient, fast response speed, high precision, a high repetition rate, good compatibility, and so forth, so as to meet various requirements including fast response speed and reliability. Furthermore, the photoconductive semiconductor switch 110 may be a coplanar waveguide structure. The detection system 1A may provide an electrical signal (not shown) to the photoconductive semiconductor switch 110 and the first mixing frequency light L1 with the first frequency f1, so that the photoconductive semiconductor switch 110 outputs a first electrical signal ES1 with the first frequency f1 in substance.

In this disclosure, the digital acquisition system DAQ (also referred to as a data acquisition system) may be an electronic measurement instrument configured to collect, monitor, and record electrical signals and data. The electrical signals may come from the photoconductive semiconductor switch 110 or sensors (such as the first object to be tested DO1), and the digital acquisition system DAQ is configured to convert these signals into a digital form for analysis, processing, and recording. In some embodiments, the digital acquisition system DAQ may include sensors to convert different physical quantities (such as voltages or currents) into analog signals. The digital acquisition system DAQ may include a signal modulator (not shown) to modulate the acquired signals (e.g., including steps of amplification, filtering, linearization, and so on). In some embodiments, the digital acquisition system DAQ may include an analog-to-digital converter (ADC) to execute time domain signals, and may convert the mixing frequency signal MS into a frequency domain signal through Fast Fourier Transform (FFT). In some embodiments, the digital acquisition system DAQ may include an oscilloscope, which should not be construed as a limitation in the disclosure.

In this disclosure, it should be particularly noted that a mixing frequency signal MS is output after the photoconductive semiconductor switch 110 and the first object to be tested DO1 are coupled. The digital acquisition system DAQ is configured to receive the aforementioned mixing frequency signal MS to detect a bandwidth range of the first object to be tested DO1.

Specifically, the first object to be tested DO1 may be, for instance, a high-bandwidth electro-optic modulator (EOM). The electro-optic modulator is constructed by electro-optic crystals, such as lithium niobate (LiNbO₃), gallium arsenide (GaAs), and lithium tantalate (LiTaO₃) crystals, which exhibit electro-optic effects. The electro-optic effect refers to the change in a refractive index of the electro-optic crystals when a voltage is applied. This results om a modification of the optical properties of the light passing through the electro-optic crystals, enabling modulation of the phase, the amplitude, the intensity, or the polarization state of the light signal. In the detection system 1A, the “coupling of the photoconductive semiconductor switch 110 and the first object to be tested DO1” refers to the interaction between the first electrical signal ES1 generated by the photoconductive semiconductor switch 110 and the first object to be tested DO1. For instance, the first object to be tested DO1 may create the electro-optic effect after receiving the first electrical signal ES1, which should however not be construed as a limitation in the disclosure. Additionally, the first object to be tested DO1 further receives a second mixing light L2. As a result, the first frequency f1 of the first electrical signal ES1 and the second frequency f2 of the second mixing light L2 may undergo frequency mixing in the first object to be tested DO1, enabling the first object to be tested DO1 to generate the light signal LS. A frequency of the light signal LS is, for instance, the beat frequency signal of the first frequency f1 and the second frequency f2, i.e., the frequency value is substantially (f1−f2), and the detection system 1A may include a low-speed photoelectric conversion element (to be described later) to receive the light signal LS and convert the light signal LS into the mixing frequency signal MS with a frequency of (f1−f2). Finally, the digital acquisition system DAQ may read and analyze the mixing frequency signal MS to determine the bandwidth of the first object to be tested DO1.

For instance, the first frequency f1 and the second frequency f2 may have a frequency difference of 1 GHz. If the first frequency f1 and the second frequency f2 are within an operating frequency range (i.e., the bandwidth) of the first object to be tested DO1, the first object to be tested DO1 may respond to the first electrical signal ES1 and the second mixing light L2 and output the light signal LS with a frequency of (f1−f2)=1 GHz. The digital acquisition system DAQ may then read and analyze the mixing frequency signal MS with a frequency of 1 GHz. By modulating the value of the first frequency f1 of the first mixing light L1 or modulating the value of the second frequency f2 of the second mixing light L2 through the frequency-tunable laser module 100A, the frequency difference between the first frequency f1 and the second frequency f2 may be changed (e.g., a frequency difference of 15 GHz to 200 GHz). Repeating the above-mentioned steps allows for scanning the bandwidth range of the first object to be tested DO1, thus completing the bandwidth detection of the first object to be tested DO1.

Since the tunable frequency range of the light beam emitted by the frequency-tunable laser module 100A is relatively wide (e.g., greater than 200 GHz), a relatively wide bandwidth may be measured. Moreover, as the frequency (f1−f2) of the light signal LS is lower compared to the first frequency f1 and the second frequency f2, the detection system 1A may replace an electronic frequency mixer, reduce the use of electronic transmission terminals and wires for electrical signals, and decrease the use of frequency reducers, thereby reducing signal loss. Besides, the detection system 1A may not require the use of high-resolution spectrometers nor frequency spectrum analyzers, which may lower the cost of the detection instruments.

In some embodiments, the detection system 1A may further include a photoelectric conversion element 120 that is configured to convert the light signal LS into an electrical signal, namely the mixing frequency signal MS, and then transmit the mixing frequency signal MS to the digital acquisition system DAQ for reading and analysis to detect the bandwidth of the first object to be tested DO1. The photoelectric conversion element 120 may be electrically connected or directly connected to the digital acquisition system DAQ. The photoelectric conversion element 120 may be, for instance, a photodiode or other types of photoelectric conversion elements, which should however not be construed as a limitation in the disclosure. Since the frequency of the light signal LS is relatively low, a bandwidth of the photoelectric conversion element 120 may be smaller than the bandwidth of the first object to be tested DO1. In some embodiments, the bandwidth of the photoelectric conversion element 120 may be less than or equal to 36 GHz or may be less than 10 GHz, which should however not be construed as a limitation in the disclosure.

Some additional embodiments are provided below to explain the disclosure in detail. In these embodiments, identical components are designated by the same reference numbers, and explanations of the same technical content will be omitted. The omitted sections may be referenced as described in the previous embodiments and will not be repeated hereinafter.

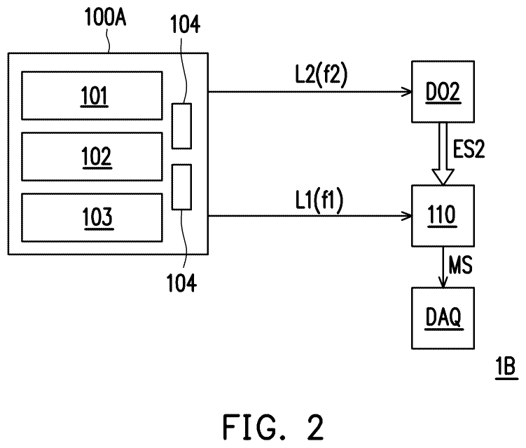

FIG. 2 is a schematic diagram illustrating a detection by a detection system according to an embodiment of the disclosure. With reference to FIG. 2, a detection system 1B provided in the disclosure is similar to the detection system 1A, while a main difference lies in the coupling method between the photoconductive semiconductor switch 110 and a second object to be tested DO2. Specifically, in the detection system 1B, the second object to be tested DO2 receives the second mixing frequency light L2 and generates the second electrical signal ES2, and the second electrical signal ES2 is transmitted to the photoconductive semiconductor switch 110. As such, the frequency of the second electrical signal ES may be the second frequency f2 of the second mixing frequency light L2 in substance. On the other hand, the photoconductive semiconductor switch 110 also receives the first mixing frequency light L1. Therefore, the second electrical signal ES2 and the first mixing frequency light L1 may undergo frequency mixing in the photoconductive semiconductor switch 110 to generate the mixing frequency signal MS.

Specifically, the second object to be tested DO2 may be, for instance, a high-bandwidth photodiode, optical transistor, or other photoelectric conversion elements capable of converting light signals into electrical signals. This disclosure does not limit the type of photoelectric conversion element. In the detection system 1B, the “coupling between the photoconductive semiconductor switch 110 and the second object to be tested DO2” means that the second object to be tested DO2 electrically connected to the photoconductive semiconductor switch 110 enables the generated second electrical signal ES2 to be transmitted to the photoconductive semiconductor switch 110. Therefore, the second frequency f2 of the second electrical signal ES2 and the first frequency f1 of the first mixing frequency light L1 may undergo frequency mixing in the photoconductive semiconductor switch 110, enabling the photoconductive semiconductor switch 110 to generate an electrical signal, namely the mixing frequency signal MS. The frequency of the mixing frequency signal MS may be, for instance, the beat frequency signal of the first frequency f1 and the second frequency f2, i.e., the frequency value is substantially (f1−f2), and the digital acquisition system DAQ may receive the mixing frequency signal MS. Finally, the digital acquisition system DAQ may read and analyze the mixing frequency signal MS to determine the bandwidth of the second object to be tested DO2.

For instance, the first frequency f1 and the second frequency f2 may have a frequency difference of 1 GHz. If the second frequency f2 is within the frequency range (i.e., bandwidth) where the second object to be tested DO2 may receive or transmit signals, the second object to be tested DO2 may respond to the second mixing frequency light L2 and output the second electrical signal ES2 with the second frequency f2. The high-frequency first mixing frequency light L1 and the second electrical signal ES2 are then input to the photoconductive semiconductor switch 110, and the photoconductive semiconductor switch 110 outputs the mixing frequency signal MS with a frequency of 1 GHz. The digital acquisition system DAQ may then read and analyze the mixing frequency signal MS. By modulating the value of the first frequency f1 of the first mixing frequency light L1 or modulating the value of the second frequency f2 of the second mixing frequency light L2 through the frequency-tunable laser module 100A, the frequency difference between the first frequency f1 and the second frequency f2 may be changed (e.g., a frequency difference of 15 GHz to 200 GHz). Repeating the above-mentioned steps allows for scanning the bandwidth range of the second object to be tested DO2, thus completing the bandwidth detection of the second object to be tested DO2. Since frequency mixing is performed by the photoconductive semiconductor switch 110, the detection system 1B does not require expensive high-resolution spectrometers, frequency spectrum analyzers, frequency mixers, or down-converters, and the detection system 1B may still achieve similar advantages as the detection system 1A, which will not be repeated hereinafter.

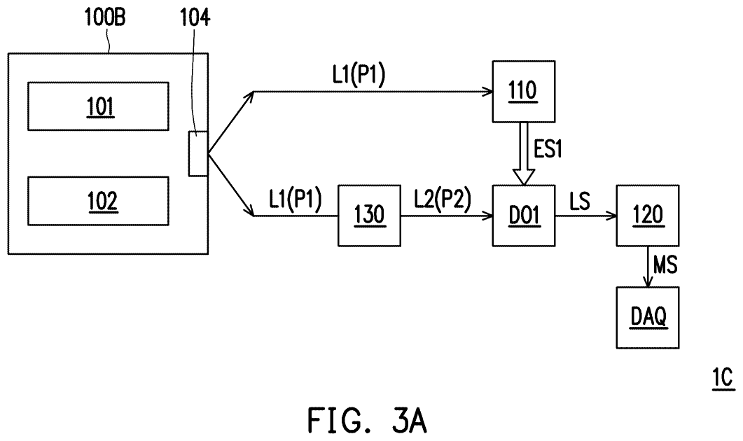

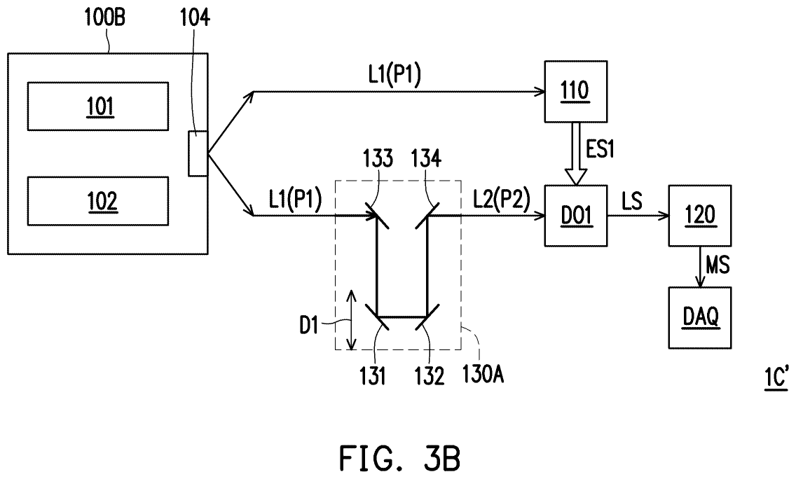

FIG. 3A is a schematic diagram illustrating a detection by a detection system according to an embodiment of the disclosure. With reference to FIG. 3A, a detection system 1C provided in the disclosure is similar to the detection system 1A, while a main difference lies in that the type of a frequency-tunable laser module 100B is different, and there is a phase difference between the first mixing frequency light L1 and the second mixing frequency light L2. Specifically, the frequency-tunable laser module 100B may include an optical delay line 130, and the first light source 101 and the second light source 102 may provide two beams of the first mixing frequency light L1, both with the first frequency f1 and the first phase P1. The optical delay line 130 may generate a phase difference in one of the two beams of the first mixing frequency light L1 to produce the second mixing frequency light L2 with a second phase P2. In other words, the first mixing frequency light L1 and the second mixing frequency light L2 may be coherent light with a phase difference, such as π or 2π in substance, which should however not be construed as a limitation in the disclosure.

For instance, when the first mixing frequency light L1 passes through the optical delay line 130, the optical delay line 130 may generate a light path difference in the first mixing frequency light L1, thereby transforming the first mixing frequency light L1 that passes through the optical delay line 130 into the second mixing frequency light L2 with the second phase P2. When the photoconductive semiconductor switch 110 receives the first mixing frequency light L1 with the first frequency f1, the photoconductive semiconductor switch 110 may output the first electrical signal ES1 with the first frequency f1 in substance. Additionally, the first object to be tested DO1 also receives the second mixing frequency light L2. As a result, the first electrical signal ES1 with the first phase P1 and the second mixing frequency light L2 with the second phase P2 may interfere within the first object to be tested DO1, enabling the first object to be tested DO1 to generate the light signal LS. Subsequently, after the light signal LS is transmitted to the photoelectric conversion element 120, the mixing frequency signal MS may be output. Since the first electrical signal ES1 and the second mixing frequency light L2 are coherent and have a phase difference therebetween, the frequency of the light signal LS generated through the interference between the two signals may be a low-speed frequency (approximating to a DC signal). Therefore, the bandwidth of the photoelectric conversion element 120 may also be smaller than the bandwidth of the first object to be tested DO1. The digital acquisition system DAQ may then perform coherent sampling to receive the time domain signal of the mixing frequency signal MS and convert it to a frequency domain signal. Finally, the digital acquisition system DAQ may read and analyze the mixing frequency signal MS to determine the frequency magnitude of the mixing frequency signal MS. Similar to the above, the frequency-tunable laser module 100B may modulate the value of the first frequency f1 of the first mixing frequency light L1, and by repeating the above-mentioned steps, the bandwidth range of the first object to be tested DO1 may be scanned, thus completing the bandwidth detection of the first object to be tested DO1.

Due to the relatively wide tunable frequency range of the frequency-tunable laser module 100B, a relatively broad bandwidth may be measured, and the detection system 1C does not require expensive high-resolution spectrometers and frequency spectrum analyzers. Moreover, applying the optical delay line 130 to perform coherent sampling may suppress noise generated during the detection process, thus effectively enhancing the sensitivity of the detection system 1C.

FIG. 3B is a schematic diagram illustrating a detection by the detection system depicted in FIG. 3B according to a modified embodiment of the disclosure. With reference to FIG. 3B, a detection system 1C′ disclosed herein is similar to the detection system 1C, while a main difference lies in that an optical delay line 130A is a tunable optical delay line. Specifically, the optical delay line 130A may have reflective lens assemblies 131, 132, 133, and 134. The spacing between the reflective lens assemblies 131, 132, 133, and 134 may be adjusted by microelectromechanical elements (for instance, a distance D1 between the reflective lens assemblies 131 and 132 and the reflective lens assemblies 133 and 134 may be adjusted). As such, the phase difference between the first mixing frequency light L1 and the second mixing frequency light L2 may be modulated by altering a length of a light propagation path in the optical delay line 130A, thereby enabling the optical delay line 130A to have enhanced flexibility and application values.

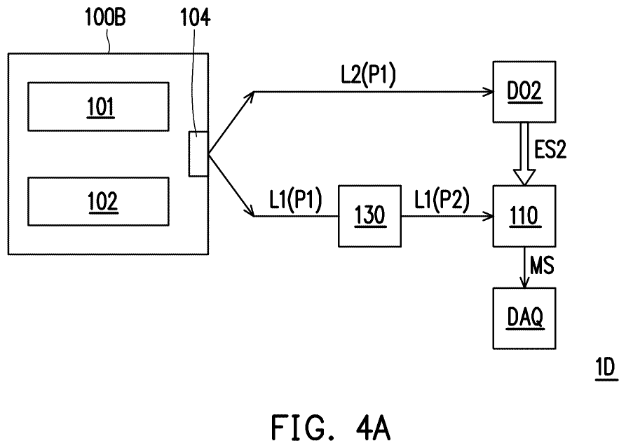

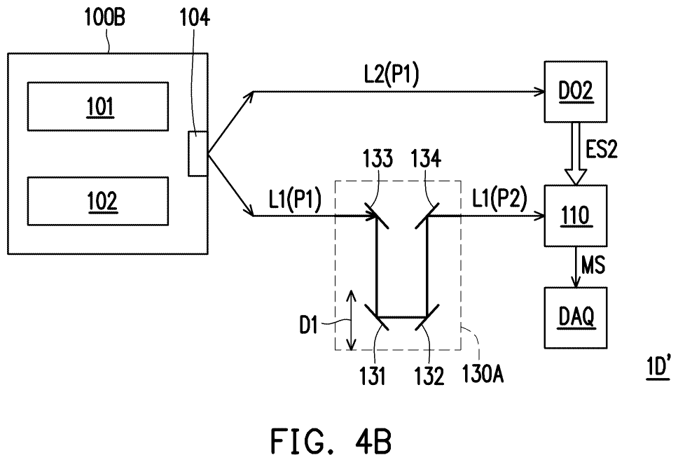

FIG. 4A is a schematic diagram illustrating a detection by a detection system according to an embodiment of the disclosure. With reference to FIG. 4A, a detection system 1D disclosed herein is similar to the detection system 1C, while a main difference lies in the coupling method between the photoconductive semiconductor switch 110 and the second object to be tested DO2. Specifically, after the second object to be tested DO2 receives the second mixing frequency light L2 with a first phase P1, the second object to be tested DO2 may output a second electrical signal ES2 with the first phase P1 to the photoconductive semiconductor switch 110. On the other hand, when the first mixing frequency light L1 passes through the optical delay line 130, the optical delay line 130 may generate a light path difference between the first mixing frequency light L1 and the second mixing frequency light L2, for instance, converting the first mixing frequency light L1 with the first phase P1 to the first mixing frequency light L1 with the second phase P2 before transmitting it to the photoconductive semiconductor switch 110. As a result, the second electrical signal ES2 with the first phase P1 and the first mixing frequency light L1 with the second phase P2 may interfere in the photoconductive semiconductor switch 110, thus enabling the photoconductive semiconductor switch 110 to generate the mixing frequency signal MS. The digital acquisition system DAQ may then perform coherent sampling and receive the time domain signal of the mixing frequency signal MS through FFT to convert the mixing frequency signal MS to the frequency domain signal. Finally, the digital acquisition system DAQ may read and analyze the mixing frequency signal MS to determine the frequency magnitude of the mixing frequency signal MS. Similar to the above, the frequency-tunable laser module 100B may modulate the frequency magnitude of the first mixing frequency light L1 (or the second mixing frequency light L2), and by repeating the above steps, the bandwidth range of the second object to be tested DO2 may be scanned, thus completing the bandwidth detection of the second object to be tested DO2.

FIG. 4B is a schematic diagram illustrating a detection by the detection system depicted in FIG. 4B according to a modified embodiment of the disclosure. With reference to FIG. 4B, a detection system 1D′ disclosed herein is similar to the detection system 1D, while a main difference lies in that the optical delay line 130A is a tunable optical delay line. Therefore, the detection system 1D′ may also modulate the phase difference by altering the length of the light propagation path in the optical delay line 130A, so as to guarantee the enhanced flexibility and application values of the detection system 1D'. Accordingly, the detection system 1D′ may achieve technical effects similar to those of the detection system 1D and the detection system 1C′. The related functionalities may be referenced as described in the previous paragraphs and will not be repeated hereinafter.

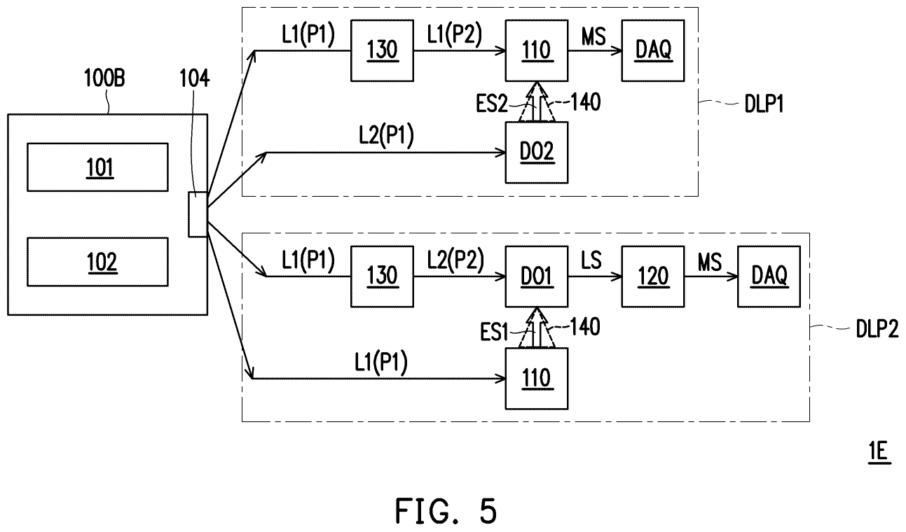

FIG. 5 is a schematic diagram illustrating a detection by a detection system according to an embodiment of the disclosure. With reference to FIG. 5, a detection system 1E is similar to the detection systems 1C and 1D, while a main difference lies in that the detection system 1E further includes the probe 140 connected to the photoconductive semiconductor switch 110, and the probe 140 is configured to transmit the first electrical signal ES1 to the first object to be tested DO1 or transmit the second electrical signal ES2 to the photoconductive semiconductor switch 110.

In detail, the detection system 1E may be considered as the detection systems 1C and 1D that are integrated. For instance, a first detection light path DLP1 of the detection system 1E may include the detection system 1C, while a second detection light path DLP2 may include the detection system 1D. Moreover, a light splitter (not shown) of the detection system 1E may provide the first mixing frequency light L1 and the second mixing frequency light L2 to the first detection light path DLP1 and the second detection light path DLP2, respectively. At this point, the detection system 1E may simultaneously detect the bandwidth of the first object to be tested DO1 and the bandwidth of the second object to be tested DO2. The related functionalities and methods may be referenced as described in the previous paragraphs and will not be repeated hereinafter. Besides, the probe 140 is, for instance, a high-frequency probe and has advantages of low loss and fast signal transmission. The probe 140 may introduce the high-frequency first electrical signal ES1 into the first object to be tested DO1 and introduce the high-frequency second electrical signal ES2 into the photoconductive semiconductor switch 110 to enhance signal transmission effects. It is worth mentioning that the detection systems provided in the previous embodiments may further include the probe 140 connected to the photoconductive semiconductor switch 110, so as to transmit the first electrical signal ES1 to the first object to be tested DO1 or transmit the second electrical signal ES2 to the photoconductive semiconductor switch 110.

It will be apparently addressed to those skilled in the art that various modifications and variations can be made to the structure of the disclosed embodiments without departing from the scope or spirit of the disclosure. In view of the foregoing, it is intended that the disclosure cover modifications and variations of the disclosure provided they fall within the scope of the following claims and their equivalents.

What is claimed is:

1. A detection system for detecting a bandwidth of an object to be tested, the detection system comprising:
a frequency-tunable laser module for providing a first mixing frequency light and a second mixing frequency light, wherein there is a phase difference or a frequency difference between the first mixing frequency light and the second mixing frequency light;
a photoconductive semiconductor switch for receiving the first mixing frequency light, wherein the object to be tested receives the second mixing frequency light, and the photoconductive semiconductor switch and the object to be tested are coupled to output a mixing frequency signal; and
a digital acquisition system for receiving the mixing frequency signal to detect the bandwidth of the object to be tested.

2. The detection system according to claim 1, wherein the frequency-tunable laser module further comprises an optical delay line for generating the phase difference between the first mixing frequency light and the second mixing frequency light.

3. The detection system according to claim 1, wherein the photoconductive semiconductor switch generates a first electrical signal after receiving the first mixing frequency light and transmits the first electrical signal to the object to be tested, so that a frequency of the first electrical signal and a frequency of the second mixing frequency light are mixed in the object to be tested to generate a light signal,
wherein the detection system further comprises a photoelectric conversion element for converting the light signal into the mixing frequency signal, wherein a bandwidth of the photoelectric conversion element is smaller than the bandwidth of the object to be tested.

4. The detection system according to claim 3, further comprising a probe connected to the photoconductive semiconductor switch for transmitting the first electrical signal to the object to be tested.

5. The detection system according to claim 1, wherein the object to be tested generates a second electrical signal after receiving the second mixing frequency light and transmits the second electrical signal to the photoconductive semiconductor switch, so that a frequency of the second electrical signal and a frequency of the first mixing frequency light are mixed in the photoconductive semiconductor switch to generate the mixing frequency signal.

6. A detection method for detecting a bandwidth of an object to be tested by a detection system, the detection method comprising:
providing a first mixing frequency light and a second mixing frequency light by a frequency-tunable laser module, wherein there is a phase difference or a frequency difference between the first mixing frequency light and the second mixing frequency light;
receiving the first mixing frequency light by a photoconductive semiconductor switch, receiving the second mixing frequency light by the object to be tested, and outputting a mixing frequency signal by the photoconductive semiconductor switch and the object to be tested after the photoconductive semiconductor switch and the object to be tested are coupled; and
receiving the mixing frequency signal by a digital acquisition system to detect the bandwidth of the object to be tested.

7. The detection method according to claim 6, wherein the frequency-tunable laser module further comprises an optical delay line for generating the phase difference between the first mixing frequency light and the second mixing frequency light.

8. The detection method according to claim 6, wherein the photoconductive semiconductor switch generates a first electrical signal after receiving the first mixing frequency light and transmits the first electrical signal to the object to be tested, so that a frequency of the first electrical signal and a frequency of the second mixing frequency light are mixed in the object to be tested to generate a light signal,
wherein the detection system further comprises a photoelectric conversion element for converting the light signal into the mixing frequency signal, wherein a bandwidth of the photoelectric conversion element is smaller than the bandwidth of the object to be tested.

9. The detection method according to claim 8, further transmitting the electric signal to the object to be tested by a probe connected to the photoconductive semiconductor switch.

10. The detection method according to claim 6, wherein the object to be tested generates a second electrical signal after receiving the second mixing frequency light and transmits the second electrical signal to the photoconductive semiconductor switch, so that a frequency of the second electrical signal and a frequency of the first mixing frequency light are mixed in the photoconductive semiconductor switch to generate the mixing frequency signal.
